(19) United States
(12) Patent Application Publication
(10) Pub. No.: US 2024/0249124 A1
(43) Pub. Date: Jul. 25, 2024

(54) SYSTEM AND METHOD OF NEURAL NETWORK PROCESSING REDUCING INSTRUCTION USAGE

(71) Applicant: Neuralmagic Inc., Somerville, MA (US)

(72) Inventors: Nir SHAVIT, Cambridge, MA (US); Alexander MATVEEV, Cambridge, MA (US); Tyler Michael SMITH, Somerville, MA (US)

(73) Assignee: Neuralmagic Inc., Somerville, MA (US)

(21) Appl. No.: 18/419,872

(22) Filed: Jan. 23, 2024

Related U.S. Application Data
(60) Provisional application No. 63/440,596, filed on Jan. 23, 2023.

(51) Int. Cl. G06N 3/048

(52) U.S. Cl. CPC G06N 3/048

(57) ABSTRACT

A system and method for executing or training a neural network (NN) may, using a computer processor, for a matrix A, for each row in A, for each unique value z appearing in one or more locations in the row in A: summing the set of rows in a matrix B where the set of rows in matrix B correspond to the indices of z in the row in A, the summing producing a vector, multiplying the vector by the unique value z to produce a product vector; and adding the product vector to a row in an output matrix C which corresponds to the row in A.

### RELATED APPLICATION DATA

The present application claims benefit from U.S. provisional Patent Application No. 63/440,596, filed on Jan. 23, 2023, incorporated herein by reference in its entirety.

### FIELD OF THE INVENTION

The present invention relates generally to the field of neural networks (NNs). More specifically, the present invention relates to the efficient use of quantized or low-precision data to perform NN operations.

### BACKGROUND OF THE INVENTION

Neural networks (NN) or connectionist systems are computing systems inspired by biological computing systems, but operating using manufactured digital computing technology. NNs are made up of computing units typically called neurons (which are artificial neurons or nodes, as opposed to biological neurons), arranged for example in layers and communicating with each other via connections links or edges. In common NN implementations, the signal at the link between artificial neurons or nodes can be for example a real number, and the output of each neuron or node can be computed by function of the (typically weighted) sum of its inputs, such as a rectified linear unit (ReLU) function. NN links or edges typically have a weight that adjusts as learning proceeds.

In practice, a NN, or NN learning, can be simulated by one or more computing nodes or cores, such as generic central processing units (CPUs, e.g. as embodied in personal computers) or graphics processing units (GPUs such as provided by Nvidia Corporation). ANN can be modelled as a mathematical object and translated physically to a CPU or GPU as for example matrix operations where entries in the matrix represent neurons, edges or links and matrix functions represent functions of the NN. CPUs typically have few cores (e.g. less than 10, or several tens); while GPUs typically have thousands of cores.

NNs are often organized in layers, from input through hidden layers, to output, where layers closer to the input typically execute in an execution order before layers towards the output; other structures may be used. When discussed herein a previous or earlier layer is located more towards the input of the NN than layers that are later, after, or subsequent: thus typically layer X immediately previous to layer Y sends its output to layer Y, and layer Y is subsequent to layer X. An earlier layer more towards NN input is before a later layer that is more towards NN output. Going backwards typically means going towards NN input.

Specialized quantized hardware instructions or operations have been devised to speed up matrix multiplications, in particular in machine learning (ML) applications. Quantization may include a compression technique that allows weights and/or activations of a NN to be reduced in size or compressed, for example from a FP32 32 bit floating point representation (e.g. single-precision floating-point format represented using 32 bits) to lower precision of FP16, BF16 (bfloat16, Brain Floating Point, storing a floating point number using 16 bits), INT8 (an integer stored using 8 bits), INT4 (an integer stored using 4 bits) and even single bit representations. By reducing the size or precision of weights and/or activations to, for example, 8-bit integers, one can move more operations through the memory hierarchy and instruction pipelines and thus deliver improved performance.

Neural Network Models can be pruned and quantized. Typically today quantization is to 4 or 8-bits in kernels, and if used in activations, to 8-bits in activations, but it can be much lower, reaching 4, 3, 2 or even a single bit. For many models, including large language models (LLMs), quantization of weights to low-bit precision while keeping activations at a higher precision ((FP32, Bfloat16, FP8, Int16, Int8 etc.) can maintain overall accuracy while offering an advantage in terms of data movement, as more weights and activations can be packed into a word and thus the bandwidth of moving kernels and data from memory to cache and between caches can be reduced. Recent research has suggested that for LLMs it is possible to quantize to reduce the number of bits in kernel weights to 3 or even 2 bits together with sufficiently high levels of pruning to sparsify the model. In this scenario the activations quantization can be high bit levels, e.g., 8 bits or higher (or FP32, Bfloat16, INT16, FP8 etc.), as long as the kernel weights are low bit. This low bit weight computing is also useful at the edge and in mobile applications, where there is a need to compress the model size to fit on small devices that have limited memory and use lower power operations.

Precision in the context of NNs may be a measure of the detail in which a numerical data item is expressed, may be measured in bits or by reference to a storage format (e.g. INT8), and is related to the concept of mathematical precision. A single quantized AVX512 vector neural network instruction (e.g., VNNI) operation can for example execute four times more operations at the same time when using INT8 relative to an FP32 FMA (fused multiply-add) instruction. The number of instructions in such an example is cut by four times, and the data that can be moved through the memory and caching hierarchy to facilitate the operation is four times (4×) the FP32 throughput. However, these quantized operations come at a cost: accuracy is lost when operating at lower precision, in particular the accuracy of the weights which are applied multiple times and may be the subject of special quantization-aware neural network training procedures.

### SUMMARY OF THE INVENTION

A system and method for executing or training a neural network (NN) may, using a computer processor, for a matrix A, for each row in A, for each unique value z appearing in one or more locations in the row in A: summing the set of rows in a matrix B where the set of rows in matrix B correspond to the indices of z in the row in A, the summing producing a vector; multiplying the vector by the unique value z to produce a product vector; and adding the product vector to a row in an output matrix C which corresponds to the row in A.

Embodiments may use the low bit accuracy of quantized weight tensor or kernels improve performing general matrix multiply (GEMM) in NN processing, and in particular also a kernel-sparse GEMM (called a sparse-dense GEMM in the literature), where there are few weights in the kernel matrix (e.g. a sparse kernel) which includes mostly 0 values. A NN tensor when discussed herein may be a structure holding NN values, such as a matrix. Since in some embodiments the improvement of the use of lower-precision may only be reduced data movement (and increased amount of data that can be stored in cache as opposed to memory), and not a decreased rate of computation, some embodiments may characterized as using quantization as compression. Other embodiments may reduce computation. NN processing may be improved by for example reducing instruction usage and allowing for fewer instructions to be used for each matrix multiply, or for activation/kernel multiplications.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a graph of a portion of a NN which may be operated on or computed according to an embodiment of the present invention.

FIG. 2 depicts a matrix multiply process according to one embodiment.

FIG. 3 is a flowchart depicting a method according to embodiments of the present invention.

FIG. 4 shows a high-level block diagram of an exemplary computing device which may be an example target architecture used with embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in specific forms other than the examples presented herein without departing from the spirit or essential characteristics thereof. The foregoing embodiments are therefore to be considered in all respects illustrative rather than limiting of the invention described herein. Scope of the invention is thus indicated by the appended claims, rather than by the foregoing description.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

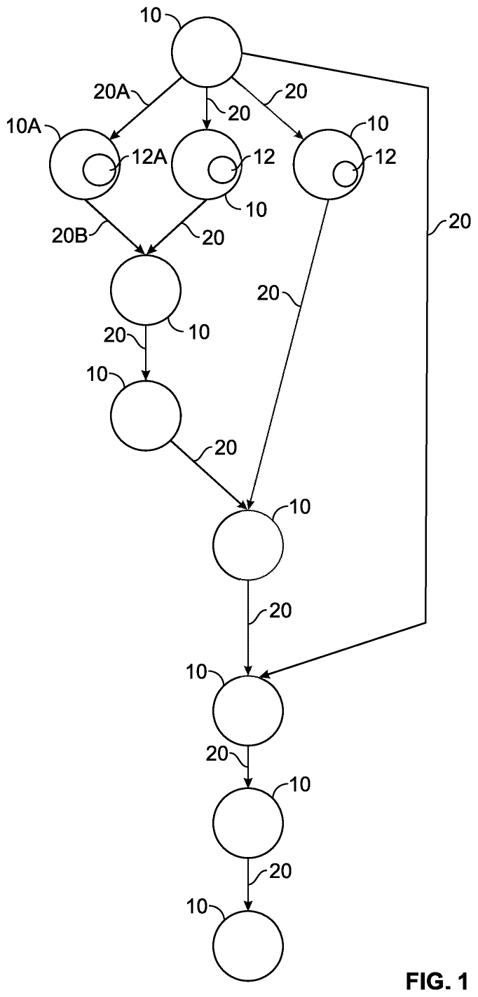

FIG. 1 is a graph of a portion of a NN which may be operated on or computed according to an embodiment of the present invention. FIG. 1 represents a layer of a LLaMA large language model, which includes a number of layers or sub-layers. Each layer (or sub layer) 10 may include thousands of neurons, and each edge 20 describes a connection between layers 10, along with the data in that connection (e.g. a tensor). A layer 10 may include a weight or kernel tensor 12 (only a few such tensors are shown for clarity). A matrix multiply (e.g. GEMM) operation in layer 10A may be performed by multiplying weight tensor 12A by an activation tensor provided as part of edge 20A, to produce output (e.g. activation) as part of edge 20B. In a typical embodiment the operations of neurons are performed by processors such as CPUs, GPUS, etc., but other processors or dedicated circuitry may be used as well.

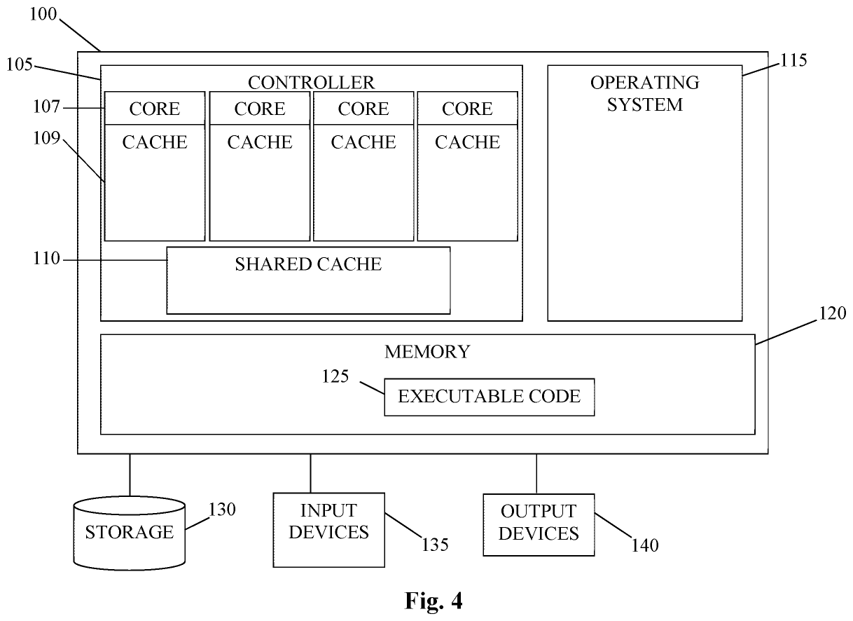

While the portion of the NN shown in FIG. 1 is a portion of a LLM, embodiments of the invention may work with other NNs, for example a convolutional NN (CNN), recurrent neural network, long short-term memory NN (LSTM), U-net, or another other type of neural network. A target architecture such as a processor 105 (e.g. FIG. 4) executing a NN may be, e.g. a central processing unit (CPU) such as a general purpose processor, a graphics processing unit (GPU), dedicated hardware or circuitry, or another type of processing unit.

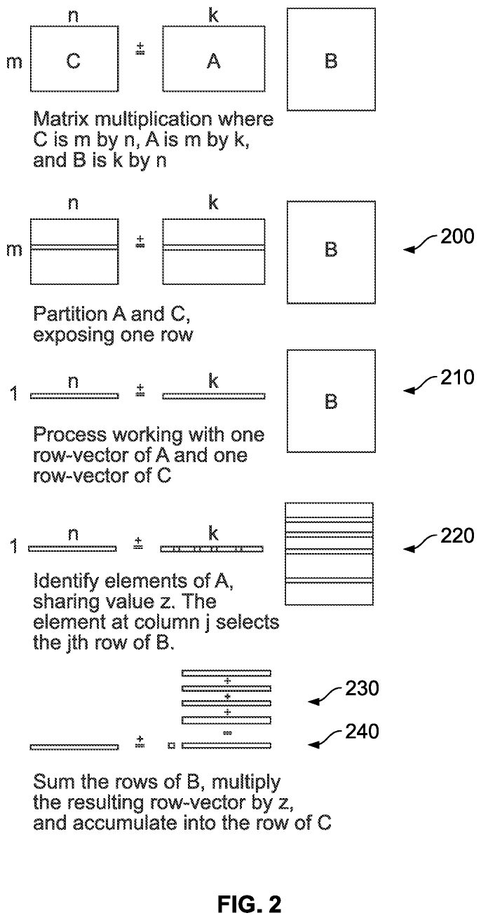

An embodiment may execute (e.g. perform inference using, or train) a NN using operations in a “reverse” order, to multiply matrices by first summing activation values (or values of inputs to a layer or NN) in an activation tensor or matrix which correspond to one specific unique value in a kernel or weight tensor (where in some embodiments a set of rows in an activation matrix correspond to the indices of the unique value), then multiplying the resulting sum by the specific unique value. FIG. 2 depicts a NN matrix multiply process according to one embodiment. Referring to FIG. 2, a process may partition (operation 200) tensors or matrices A and C into corresponding rows when multiplying matrices A (dimensions m by k) x B (k by n) to produce C (m by n). A process may iterate over rows of a weight or kernel tensor A, and for a row R in A which corresponds to a row in C (operation 210), for each occurrence of a unique value z in that row R of A (operation 220), identify the index or position of each of possibly multiple occurrences of that unique value in row R: this may produce a set of one or more indices, each index corresponding to an occurrence or column of the same unique value z in row R of A. A process may determine or find the subset S of rows of activation tensor B (identified at operation 220) where each row in the subset S corresponds to or is indexed by one of these indices of z; for example if value z occurs in row R in A in positions 2, 5 and 7, subset S includes rows 2, 5 and 7 of B. A process may then add the rows (of B) of subset S (e.g. add the corresponding values of different vectors using vector addition, summing values in corresponding positions across different rows), to produce a resulting sum vector (operation 230). The resulting sum vector may be multiplied by the unique value z (operation 240), and the resulting product vector may be accumulated to or added to the row in C corresponding to row R in A (this corresponding row may be the row with the same index; e.g. if the row having index R in A is searched for unique values, the resulting vector may be accumulated to the row indexed R in C). A process may, within row R in A continue to the next unique value z and repeat the above process. The process may, after finishing with all unique values in row R in A, continue the iteration with row R+1 in A to sequentially take all rows in A.

Embodiments of the invention may process neural network execution, including inference (e.g. during runtime or production) and training.

NN activations may be the values output from one layer to another. One embodiment may, for an output tensor C calculated from a weight tensor A and an activation matrix B, produce an output entry C[x,y] in tensor C by, for each unique value z in A, summing, for each separate A[x,b] having value z and coordinates x and b, the activation values in B corresponding to A[b,y] having coordinates b, y to produce a sum (e.g. of all activations corresponding to the unique value); and multiplying that sum by z; to produce an intermediate product; then summing all the intermediate products. The summing all the intermediate products may be performed by, e.g., accumulating the summed results in an output entry. While input to a NN layer or calculation is described as activation, inputs to a layer or calculation which are used in embodiments of the present invention may be input to the NN itself. Embodiments may reduce the number of operations performed, especially in the case that the number of values from one matrix, e.g. A, may be limited: for example if A values are represented by three bits, there are only seven unique non-zero values. The values of the other matrix, e.g. activation matrix B, may have a wider range and great precision than those of matrix A, as these B numbers are typically added in embodiments of the invention, which is a low cost operation compared to multiplication.

When used herein, a value stored at a lower quantization level or precision is stored with fewer bits or bytes than that same value stored at a higher quantization level or precision: for example the value 4 may be stored using two bits or many more (e.g. using the FP32 format). The value 1,000,000 if quantized from FP32 to 4 may result in a value which, if de-quantized to FP32, is no longer the same, but embodiments may process NNs with such quantization without much or any loss in accuracy in NN processing. Quantizing a value may mean converting the value so that it is stored using fewer bits, at a lower quantization level; and de-quantizing a value from a representation may include converting the value to a representation using more bits and having more accuracy, e.g. to a higher quantization level. Various methods of converting precision, quantizing and dequantizing may be used.

Quantization may compress values such as those stored in weight tensors or kernels, or activations, by representing floating point parameters as more granular values such as integers or floating point values with less precision. Quantization may make kernels for operations like sparse convolutions and sparse matrix multiplications much smaller. The resulting kernel values may be much smaller (e.g., 2 or 4 times smaller) than their floating point counterparts. Thus an embodiment may store many more kernels in cache compared to the original dense, floating point versions, which may in turn improve NN execution speed by decreasing the need for memory access.

General matrix-matrix multiply (GEMM) is a fundamental element of much NN processing. For example, to compute activations for a layer, input may be a matrix or tensor A (or stacks of matrices) including kernel or weight values, multiplied by a matrix or tensor B including activations received from another layer, producing as an output matrix or tensor C representing output activations for that layer.

Embodiments of the present invention include new techniques for a GEMM operating on a kernel or set of weights that can execute at any weight quantization precision but will more efficiently execute low bit quantized kernels such as using values represented as 4 or lower bits, and use any quantization level (e.g. FP32 or FP16, which may be considered not quantized at all) of the activations. This GEMM technique may work for both sparse and dense GEMM (e.g. using sparse or dense kernels), but can provide better performance for sparse GEMMs.

Sparsity in the NN context may include setting some values to zero (e.g. kernel values, or weight values), with the observation that setting some values to zero does not significantly reduce NN accuracy but does reduce processing time, storage, or memory movement time. A matrix is sparse if it contains a lot of entries that are zero (0). While the input matrix of data to be processed at inference or run time (and the sparsity of the input matrix) is usually out of the network designer's control, the weights of the neural network can be made sparse using pruning. Sparsity may be achieved by pruning, for example to prune the kernels of a NN to increase the number of zero elements. If the pruning method allows zeros anywhere (in any position), it may be termed unstructured, and if a pruning method forces a pattern on where the zero and non-zero elements can be, it may be called structured pruning. Embodiments may improve NN processing using sparse kernel or weight tensors.

Embodiments may be implemented in software (e.g. using CPUs to process a NN) or accelerators like GPUs, but can also be the basis for a hardware implementation. Using CPUs, there is typically hardware support for 8 bit vector operations (e.g. AVX (Advanced Vector Extensions), AVX2 operations, VNNI (Vector Neural Network Instruction) operations, and AMX (Advanced Matrix Extensions) operations). However, in latest generation GPUs, CPUs, and other accelerators, there is currently little or no hardware support for 4 bit (or less) operations. Embodiments may address this deficiency. Embodiments may also address the case of small and mobile computing devices, which unlike commodity CPUs might not have AVX vector instructions that support low bit FMA operations (e.g. VNNI operations which use lower precision, and represent information with fewer bits than, FMA operations), and where reducing compute and the use of high power FMA operations is crucial. This may improve NN processing by effectively turning high-precision multiplication to less processor intensive high-precision addition.

Embodiments of the invention allow performing a GEMM operation, and in particular a sparse-dense GEMM (e.g. where a kernel tensor or matrix is sparse and an activation matrix or tensor is dense, e.g. not sparse), without requiring FMA instructions at all. FMA instructions are expensive because of their more complex circuitry, and because they take many cycles more than simple add or multiply instructions. On CPUs they can also throttle the CPU clock. Thus, avoiding them provides a valuable improvement in processor speed and perhaps also in overall energy expenditure, though this is hardware dependent. Sparsity may further increase improvements of embodiments of the invention, since some embodiments perform operations on indices corresponding to specific values, and typically zero values are ignored, meaning no add or multiply operations are performed at all for zero values.

Embodiments include a technique that can be used for GEMM processing with for example 8 or less bit weights and 8 bit activations, e.g. using AVX2 instructions. An example algorithm may be combined with an algorithm to pack the weights into a more compact form and unpack them before executing in the GEMM.

Such a GEMM technique is described in the context of a sparse quantized neural network computation, though it is just as applicable in other settings where a matrix multiplication needs to be performed and one matrix is in a low-bit integer representation (each value is less than standard 32-bit precision); and other contexts, e.g. those not using quantization.

Different embodiments may use different instruction sets and different circuitry to perform NN calculations as described here. One embodiment operates on relatively low bit representations of weight or kernel values without using FMA instructions to perform GEMM in NN.

In GEMM multiplication of kernel or weight tensor A, activation tensor B, and output tensor C (e.g. A*B=C), each m length row vector of A[i][1. . m] and column vector of B[1. . m][j] are multiplied, and the resulting values are summed up into the corresponding output C[i][j] location. If the matrix A is sparse, the number of multiplications and additions that are performed is proportional to the number of non-zero weights in A. In the prior art, these multiplications and additions may be executed using expensive FMA operations.

If there are a small number of bits per weight in A, then the chances that multiple weights in a row of A have the same value is high: this can be used to improve and make more efficient NN computation. For example, in the context of two (2) bit weights, then there are 4 possible values, and 3 possible non-zero values, 3, 2, and 1. Thus matrix multiplication can be performed in phases. For each output C[i][j], a process may break the computation of multiplying each A[i][1. . m] by B[1. . m][j] into a multiplication of all the 1 values in A[i][1. . m], then all the 2 values in A[i][1. . m], then all the 3 values in A[i[1. . m]] with the corresponding values in B[1. . m][j] and so on until the end of the range of values (in this example 3), or quantization accuracy limit (e.g. k=2\hat{ }1-1 for any 1-bit representation), is reached, each time adding the result to the output C[i][j]. In such a manner, the entire output matrix C, including many individual elements C[x,y], may be calculated: each individual C[x,y] calculated may be placed in the proper slot in C, to assemble C into a final output matrix of activations produced by the layer.

Performing such calculations in phases allows for reversing the order in which the operations are performed, performing all the additions for a certain set of calculations first, and then performing one multiplication by the phase's specific value or the unique value defining the summing (e.g. in this example 1 or 2 or 3). Thus multiplying matrices by first summing activation values in an activation tensor or matrix which correspond to one specific unique value in a kernel or weight tensor, then multiplying the resulting sum by the specific unique value may be performed, in the case of k unique values, so that the output value C[i][i] in an output matrix is described as:

$$C [ i ] [ j ] = ( sum of B [ x ] [ j ] for all x where the weight is 1 in A [ i ] [ x ] ) * 1 + ( sum of B [ x ] [ j ] for all x where the weight is 2 in A [ i ] [ x ] ) * 2 + … + ( sum of B [ x ] [ j ] for all x where the weight is k in A [ i ] [ x ] ) * k$$

Such an embodiment performs one multiplication per unique value in 1. . k, and all other operations are additions. This may improve NN processing as it may reduce the number of multiplications compared with prior art methods significantly: instead of being proportional to the number of non-zero values in any row of A, it is proportional to k, the bit representation of the weights which is much smaller than the number of non-zeros. In particular this may eliminate the need for FMA operations. This improvement, and the operation of this embodiment, is independent of the precision of the activation values stored in B (e.g., they can be FP32, Bfloat16, FP8, Int16, Int8 etc): the algorithm will work as long as there is an operation to add B values and multiply them by an integer. However, the improvement of embodiments of the invention is amplified the more quantized the kernel or weight values are, e.g. the fewer bits used to represent these values.

This may be performed using a method iterating over rows of A, and accumulating product vectors to corresponding rows of C (e.g. corresponding rows of A and C may share a positional index), but may be performed in different manners.

While various embodiments are discussed as multiplying matrices by matrices, in some embodiments, some of the data, e.g. activations, may be in a vector instead of a matrix, e.g. in the case of a transformer encoder/decoder model.

In some embodiments kernels or weights may be quantized such that each value in A is quantized and represented by three or fewer bits, for example three bits, two bits or one bit; and each activation value in B is not quantized, such that it is represented by eight or more bits, e.g. floating point representation, or Int8 representation. However, embodiments may work with other representations, e.g. where matrix A values are represented by more than three bits, and activations may be represented by less than eight bits. In some embodiments, the fact that a value such as a weight is quantized from, e.g. FP32, to being represented using two bits (e.g., with values 0-3) does not adversely affect NN processing, as quantization may ignore the “real world” representation of the original value, with no adverse effect.

An embodiment may improve prior NN processing methods by making use of add instructions and multiply instructions, e.g. scalar add (e.g. ADD, etc.) and multiply instructions (e.g. MUL, IMUL, etc.), such that the summing uses add instructions and the multiplication uses multiply instructions, instead of prior art method using, e.g. FMA instructions.

An embodiment may vectorize such operation, using vector operations that allow addition and multiplication: summing may use vector add instructions (e.g. ‘vaddps’, ‘vpaddsb’, ‘vpaddsw’, which are used for adding vectors of FP32, INT8, and INT16 values, respectively) and the multiplication may use vector multiply instructions (e.g. vmulld, vmulps, or vmulph, which multiply vectors of INT32, FP32, or FP16 values, respectively). Multiplication with lower-precision operations often requires up-conversion. These can be but are not limited to those available in AVX and AMX instructions on commodity CPUs, tensor core operations on GPUs, and vector operations that are weaker as might be found on specialized edge devices. To perform the vectorized operations on a kernel or weight tensor having a range of values 0-k, an embodiment may use a vector of width w over the input channel to multiply matrices using a system a first summing values corresponding to a unique value then then multiplying the resulting sum by the unique value. That the unique values which are summed have high precision or representation with many bits (e.g. FP32) typically does not lower NN processing speed by much, especially if there are few different unique numbers, at least in part because these unique numbers are summed, which may be less complex for a processor than multiplication (typically only the resulting sum is multiplied). In NNs, e.g. LLMs, it is often easier to quantize weights than activations, and embodiments of the present invention may improve NN processing by allowing for un-quantized activations to be used. Embodiments may naturally work well with sparsity, as embodiments may rely on working with a indices of a number of unique weight values. If w does not match tensor dimensions, breaking the tensor to multiple operations, and/or padding, may be used:

$$C [ i ] [ 1 … w ] = ( element wise addition of all B [ x ] [ 1 … w ] for all x where \\ the weight is 1 in A [ i ] [ x ] ) multiplied element wise by \{ 1 … 1 \} ) + ( element wise addition of all B [ x ] [ 1 … w ] for all x where the \\ weight is 2 in A [ i ] [ x ] ) multiplied element wise by \{ 2 … 2 \} ) + ( element wise addition of all B [ x ] [ 1 … w ] for all x where \\ the weight is k in A [ i ] [ x ] ) multiplied element wise by \{ k … k \} )$$

The element wise addition of all B[x][1. . w] for all x where the weight is a unique value v in A[i][x]) may be done by allocating a temporary register T[1. . w] (e.g. storing a one-dimensional vector), adding into it all the B[x][1. . w] elements, then multiplying all entries of T[1. . w] by v (the multiplication by weight v may be done by broadcasting v into an AVX register and multiplying elementwise) and finally adding T[1. . w] to C[i][1. . w] (e.g. adding T[1. . w] to the preexisting value C[i][1. . w] to accumulate the sum). Each of these can be accomplished using add and multiply AVX vector instructions, making sure that the T[1. . w] AVX register has sufficient precision to accumulate all the B[x][1. . w] of a certain x without overflow. For example, if the B[x][1. . w] are 8-bit activations, then T[1. . w] can be 16-bit precision, if B[x][1. . w] are 4-bit activations, then T[1. . w] can be 8-bit precision. One can also simply use floating point formats such as FP32 or Bfloat16 or the upcoming FP8 formats to perform add and multiply operations without worrying about overflow.

This order of execution may imply that it is better to store the activations matrix B, as is known in the art, in a format that breaks it into long streaks of width w columns, e.g. according to the cache line width or register width of the target architecture (e.g. the type of processor on which an embodiment is intended to operate) so that each column is laid out as much as possible across a cache line. For example, on a CPU target architecture using AVX2 instructions, for 8-bit activations, one can load the B[x][1. . w] using an instruction such as vpmovzxbw ymm, xmm (zero extend packed unsigned 8-bit integers in xmm to packed 16-bit integers, and store the results in ymm) and add it to T[1. . w] using an instruction such as vpaddw ymm (dst), ymm (a), ymm (b) (add packed 16-bit integers in a and b, and store the results in dst.). Such an embodiment may broadcast v using an instruction such as vpbroadcastb ymm (dst), xmm (a) (broadcast the low packed 8-bit integer from a to all elements of dst.) and multiply element wise at 16 bits using an instruction such as vpmullw ymm (dst), ymm (a), ymm (b) (multiply packed 16-bit integers in a and b into 32 bits, and store the low 16 bit results in dst.) avoiding overflow.

A typical computation of a destination or output value C[i][1. . w] using prior art dense GEMM techniques may require one FMA per w values (w being the width of a vector in the instruction; where each FMA performs w adds), and using sparse techniques state of the art GEMMs may require a broadcast of each non-zero value v followed by an FMA instruction multiplying a vector of w activation values by this non-zero value. Thus, there may be one broadcast and one FMA per instruction, and in the case where a prior art technique is using 16-bit AVX2 FMA instructions or 8-bit AVX VNNI FMA instructions there may be a need for special 2-block or 4-block formatting of the sparse weight kernels, due to the structure of AVX VNNI instructions. This block-sparse requirement is known to affect the accuracy/sparsity tradeoff in neural network pruning and quantization and so avoiding the need to use it has benefits.

In embodiments of the present invention, unlike the typical computation, for a sparse GEMM, the computation of C[i][1. . w] can help avoid both the block-sparsity requirement and the need for expensive FMA operations. Instead, some embodiments may use one AVX vector add operation per w values (w being the size of a vector), and then a broadcast and a multiply followed by an add (which can but does not have to be performed using an FMA) per each unique value 1. . k found in the row A[i][1. . m].

For a sparse matrix operation, an embodiment may implement GEMM or operations that multiply matrices by first summing activation values which correspond to one specific unique value in a kernel or weight tensor, then multiplying the resulting sum by the specific unique value, by issuing the sequence of add, multiply, and/or broadcast operations at compile time using a just-in-time (JIT) compiler, where the order of the issued vector operations is pre-defined by the sequence of operations described in various embodiments herein. A JIT embodiment may develop, from a NN, executable code which instead of including loops executing on different elements of NN data, includes all of the specific add, multiply, or other operations on specific elements of the input kernel or weight tensors. Such a JIT method may produce code or instructions for summing and multiplying as described herein based on an input of a matrix A which contains kernel or weight values. This can be contrasted with an embodiment receiving the kernel or weight tensors as data and inputting this data into instructions which are executed repeatedly for different kernel input data. For example, a JIT compiler may input a kernel tensor and for each kernel element, or each kernel row, output specific instructions, to operate on that kernel element to perform the relevant matrix multiplication.

An embodiment may, based on data (e.g. based on a weight or kernel tensor) produce code for a NN in a JIT manner, and produce, generate or issue code which may perform the add/sum and multiply operations as discussed herein, possibly as well as the surrounding operations to organize the data. For example, instructions may be generated which perform only the add and multiply operations needed as described elsewhere herein.

Alternatively, one can implement such a GEMM using a runtime loop over the kernel rows. This can be done using compressed kernel representation using, for example, a variation of the compressed sparse row (CSR) or similar representation, or using the special compressed representation described herein.

Embodiments may work with non-sparse, e.g. dense, GEMM operations. In such an embodiment, most indexes or values in a kernel or weight tensor are non-zero. An embodiment may provide a way to execute GEMM computations without FMA instructions, which may increase power efficiency on edge devices, as addition operations may be much more efficient than FMAs. The weight or kernel values may have the values ranging from in 0. . k in A[i][1. . m]. An embodiment may conduct a traversal loop to progress down or along the values A[i][1. . m] by adding 1 in the traversal loop index. A number k registers T[1. . k][1. . w] may be allocated for accumulation. For each A[i][j]=a unique value v in {0. . k}, an embodiment may perform the addition of B[1. . w][j] by choosing the appropriate T[v][1. . w] accumulation register (for every non-zero value). After finding and indexing unique values, e.g. into weight entries A[i][1. . w+j], it would multiply each register T[v][1. . w] by v and add all the T[1. . k][1. . w] to C[i][1. . w+j]. Alternately, a two-dimensional (2D) register tile may be used, such that a temporary matrix T[1. . k][1 . . . q*w] is used.

An embodiment may use value-index phased quantized compression to represent low-bit kernel or weight values efficiently. A set of lists or sets may be kept, e.g., for every kernel row A[i][1. . m], there may be k lists, one list for each unique value v, each list holding the index j in {1. . m} where the unique non-zero values or weights v in {1. . k} are. Thus, if A[i][1. . 10]=[0,1,0,2,3,0,3,0,2,0] then there may be 3 lists: the “1” list {2}, the “2” list {4,9}, and the “3” list {5,7}. Such lists may be used with different embodiments discussed herein. An embodiment may iterate a loop over the rows of A, and for each row execute a loop over width w outputs in C; and for each output C[i][1. . w] iterate a loop over the indexes in the k lists (using each k list corresponding to a unique value to find activation values corresponding to that unique value, in the sense that the unique value would be multiplied by the activation value in the prior art), performing width w AVX addition operations on the activations matrix B and storing it to C so that:

$$C [ i ] [ 1 … w ] = AVX addition of all B [ x ] [ 1 … w ] for all x in the “ 1 ” \text{} list , then AVX multiply this sum element wise by \{ 1 … 1 \} ) + AVX addition of all B [ x ] [ 1 … w ] for all x in the “ 2 ” list , then AVX multiply this sum element wise by \{ 2 … 2 \} ) + … + AVX addition of B [ x ] [ 1 … w ] for all x in the “ k ” list , then AVX multiply this sum element wise by \{ k … k \} ) .$$

This may be an efficient sparse representation of the kernel matrix A, but still requires storing indexes proportional to m. Because the loop is executing down each list, it can actually be made more efficient (for denser sparse matrices as found in LLMs) by storing only the differences in distance from the start and then from one list location to the next in the rows of B. Thus in the example above, if A[i][1. . 10]=[0,1,0,2,3,0,3,0,2,0] then there will be 3 lists, the “1” list {2} (start at index 2), the “2” list {4,5} (start at index 4 and then 4+5), and the “3” list {5,2} (start at distance 5 and then 5+2).

Some embodiments are described as a software implementation on existing CPU or other hardware. However, executing a NN by first summing activation values in an activation tensor or matrix which correspond to one specific unique value in a kernel or weight tensor, then multiplying the resulting sum by the specific unique value, may be performed using hardware other than CPUs, such as dedicated hardware. For example, an embodiment may be directly implemented on GPUs or other accelerators that offer vector based add and multiply operations. The improvements and savings of such an embodiment may be in power and efficiency due to the ability to replace FMA operations and in particular replace the majority of multiplications with adds.

An embodiment may include a specific circuit for executing a low-bit GEMM of a low-bit algorithm. The vectorization of the following example calculation:

$$C [ i ] [ j ] = ( sum of B [ x ] [ j ] for all x where the weight is 1 in A [ i ] [ x ] ) * 1 + ( sum of B [ x ] [ j ] for all x where the weight is 2 in A [ i ] [ x ] ) * 2 + … + ( sum of B [ x ] [ j ] for all x where the weight is k in A [ i ] [ x ] ) * k$$

need not to be along the spatial dimension C[i][j] as in some embodiments, and an embodiment may include a specialized VLSI (very large-scale integration) circuit or application-specific integrated circuit (ASIC) that may execute the sequence above or another embodiment in a vectorized manner. Existing specialized circuits designed for neural network executions, such as Tensor Cores circuits and AMX circuits, are typically based heavily on using expensive FMA operations, and algorithms according to embodiments of the present invention may improve processing by eliminating the need for these FMA instructions, replacing them with simple add and multiply instructions.

Embodiments may be instruction independent (e.g. may be used with a variety of different types of instructions) and may be sparsity structure independent (e.g. not requiring a certain pattern or structure for sparsity). Embodiments may work with scalar instructions, e.g. simple add and multiply instructions not reliant on vector instructions; however embodiments may use vector addition or other vector instructions.

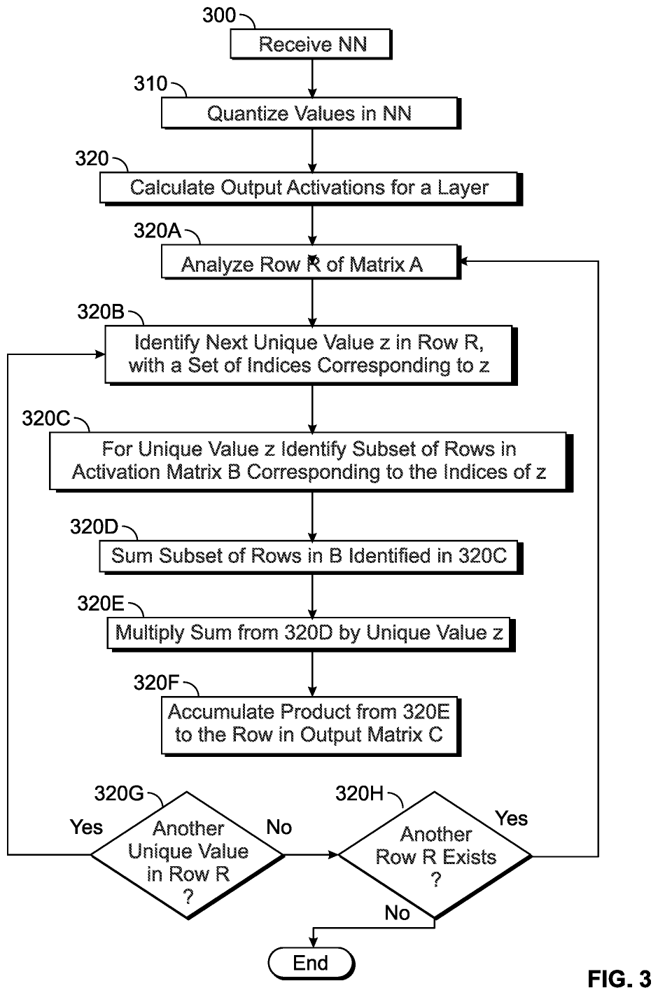

FIG. 3 is a flowchart depicting a method according to embodiments of the present invention. The operations of FIG. 3 may be used with systems such as depicted in FIGS. 1 and 4, but other systems and architectures may be used. The operations of FIG. 3 may be used for performing inference on a NN by accepting an input for the NN and producing an output from the NN, but in some embodiments some of the operations of FIG. 3 may be used for NN training. The operations of FIG. 3, or other operations as disclosed herein, may in some embodiments be considered to, for example, sum activation values which correspond to a unique value in a kernel or weight tensor, then multiply the resulting sum by the specific unique value.

In operation 300, a NN may be received, including definitions of kernels or weights.

In operation 310, the values in the kernels or weights may be quantized. For example, the precision or the number of bits representing the numbers may be reduced. In one example, weights represented as floating point values (unquantized, high precision) may be quantized and represented using two-bit representation: each of the floating point values may be mapped to one of the four values that are expressed with a two-bit representation. Any suitable quantization scheme may be used. Typically a small number of distinct values are used for weights: e.g., if 2-bit numbers are used, there are only 4 different values possible in the weights. While, in some embodiments, the actual or original (non-quantized) weight values are not important, embodiments may use a linear quantization scheme involving a scale and zero point, where one of quantized value is be picked to be zero. Values less than that “zero point” are considered negative and values greater than the zero point are considered positive. In other embodiments, the NN is quantized beforehand; e.g. a quantized NN is assumed.

In operation 320, output activations for a layer may be calculated. As part of this, weights or a kernel for a layer, e.g. represented as tensors or matrices (e.g. tensor A), may be multiplied by an input to a layer (e.g. B). Input to a layer may be, e.g. activations from a preceding layer or input to the NN. This calculation may be represented as output C=A*B. Other or additional operations may be performed when calculating output for a layer, e.g. applying activation functions such as a ReLU (rectified linear unit).

As part of operation 320, kernel or weight matrices may be multiplied by activation or input matrices. Each value or entry C[x,y] in a tensor or matrix C holding the outputs for the layer may have its value calculated through the process in operations 320A-320H.

In operation 320A, as part of an iteration over the rows of a weight or kernel tensor or matrix A, a row R of A may be analyzed (e.g. a next row if in the middle of an iteration; in some embodiments A may be iterated over starting with the first row and moving to the last, but other methods may be used). In operation 320B, as part of iterating over each unique value z in row R, a next unique value z may be identified. Sets of lists or sets may be created, as discussed elsewhere herein. In one embodiment, for each row R in A, a list of unique values may be identified before processing, each unique value being associated with or appearing in one or more positions or indices within row R; however, other methods of identifying and keeping track of unique values and their positions may be used. Thus, a set of indices or positions may be identified, each corresponding to the same unique value.

In operation 320C, for unique value z, a subset of rows in an activation or input tensor or matrix B corresponding to the index may be identified. In one embodiment, a row in B corresponds to a position or index of a value in a row in A if the number of the column, index or position of the value is the same as the number of the row in B. For example, if unique value 3 occurs in columns, indices or positions 4, 7 and 9 of row R in A, a subset including rows 4, 7 and 9 of matrix B may be identified. A row in B that corresponds to an index or position of a value (e.g. z) in a row in A may by the row in B indexed the same as in the value.

In operation 320D, the subset of rows in B identified in operation 320C (e.g. corresponding to the indices of z in the row in A) may be summed. Such summing may use add CPU instructions but other methods, such as the use of vector add instructions, a GPU, or dedicated circuitry, may be used. For example, a vector or register may be created which includes the vector sum of the subset of rows. In some embodiments, the summing of activation values before the multiplication of the resulting sum may improve NN processing, by allowing for more less costly sum operations and fewer expensive multiplication operations.

Summing the set of rows in the matrix B may include partitioning each of the set of rows in the matrix B such that the summing occurs for each partition. While some embodiments may process entire rows of a B or activation tensor, or other tensors, at once, other embodiments may work with partial rows. An embodiment may partition the rows of, e.g. B and C tensors, and loop over these partial rows, for thread parallelism or to fit the working set of those tensors into cache.

In operation 320E, the vector sum calculated in operation 320D may be multiplied by unique value z identified in operation 320B to produce a product vector. Such multiplication may use multiply CPU instructions but other methods, such as the use of vector multiply instructions, a GPU, or dedicated circuitry, may be used.

In operation 320F, the product resulting in operation 320E may be added or accumulated to the row in an output or result matrix C which corresponds to the row in A, which may be the row having the same position or index. For example, if a unique value z occurring one or more time in row 3 of A was used to produce a vector holding the product of z times one or more rows of B, the vector holding this product may be accumulated to row 3 of output tensor or matrix C.

In operation 320G, if another unique value z exists in row R, the process may proceed to operation 320B; else in operation 320H, if another row R exists, the operation may proceed to operation 320A; else the process may end. To produce the final output of activations for a layer may in some embodiments require additional operations. After NN layers are processed, an output such as activations (e.g., the output of a final layer, or another layer) of the NN may be produced. Some layers may not require matrix multiplication as described in operations 320A-320H. Other operations or series of operations may be used.

FIG. 4 shows a high-level block diagram of an exemplary computing device which may be an example target architecture used with embodiments of the present invention. In some embodiments the computing device 100 of FIG. 4 may emit or generate code for a NN, or execute NN inference or training using NNs as described herein. Computing device 100 of FIG. 4 may be a NN execution or creation platform, such as a computer within a device (e.g. a car), personal computer, laptop, smartphone, workstation, server, cloud computing system, etc. A CPU typically has a cache hierarchy with higher, faster and smaller private caches (e.g. L1, L2) and lower, larger shared caches (e.g. L3), and includes or is connected to a large but order of magnitude slower external memory such as a DRAM memory. Some embodiments of the present invention are described with respect to CPUs but can also be valuable in other architectures such as GPUs.

Target architectures used with embodiments of the present invention may include for example AMD's EPYC or Zen series of processors, or Intel's Xeon, Core, or Pentium processors, ARM (Advanced RISC Machines) Cortex or Neoverse processors, CPUs, GPUs, dedicated circuitry, and other processors.

Computing device 100 may perform functions using e.g. one or more processors such as controller or processor 105, each of which may include multiple cores 107 (e.g. 4, 18, or other numbers), each such core having associated with it one or more private or local caches, such as an L1 cache (not shown) and a larger, lower level L2 cache or buffer 109, local to or accessible only by that core. The multiple cores may share an even larger, lower level shared cache 110 (e.g. L3 cache), the caches located typically within or as part of the processor on the same chip. Different caches and cache structures may be included in other embodiments. Although example embodiments are described in terms of L1, L2, and L3 cache levels as in Intel architectures, embodiments apply to any other architecture, with different cache designs. L1 cache may be faster and smaller than L2 cache which may be faster and smaller than L3 cache. L1 cache may be faster to access by cores than L2 cache which may be faster than L3 cache. L2 and L1 may be much smaller and faster than L3 and are separate for each core; each core may have its own L1 and L2 cache while the last level, the L3 cache may be shared across all the cores on a die. Memory 120 (e.g. DRAM typically external to the die on which the cores exist) is typically larger than caches but typically an order of magnitude slower memory (e.g. DRAM). CPUs often have fewer cores (e.g. less than 10) when compared with GPUs which often have thousands of cores; CPUs often have slow memory bandwidth when compared to GPUS.

Cores 107 may access tasks, code and data via references to external memory 120. The manner and frequency of access of this data, and the size of the sections of data accessed, may cause the data to be kept in caches such as caches 109 and 110. Memory 120 may be external to processor 105 and for example not on the same chip as cores 107 and caches 109 and 110; as opposed to caches, which are typically on the same chip as the processor, local to the processor or internal to the processor, or closer to the processor than memory 120. In some embodiments, some or all of cache storage may be off-chip, not on the same chip as processors or cores, but in general, access to the is faster than access to memory 120.

Processor 105 may be one integrated circuit and cores 107 may be separate processing units each reading and executing program instructions. Thus a single processor 105 can execute different instructions or threads on different cores 107 at the same time, increasing overall speed for programs that support multithreading or other parallel computing techniques.

Computing device 100 may include an operating system 115, a memory 120, a storage 130, input devices 135 and output devices 140. Operating system 115 may be or may include any code segment to coordinate, schedule, arbitrate or control operation of computing device 100, for example, scheduling execution of programs. Memory 120 may be or may include, for example, a Random Access Memory (RAM), a read only memory (ROM), a Dynamic RAM (DRAM), a Flash memory, a volatile or non-volatile memory, or other suitable storage. Memory 120 may include a plurality of, possibly different memory units. Memory 120 may store instructions to carry out a method (e.g. code 125) as described herein, and/or data such as NN data, data describing a NN, NN kernel information, etc.

Executable code 125 may be any executable code, application, program, etc. and may be executed by controller 105. Executable code 125 may when executed cause NN execution or inference, or the generation of code of a NN, or other functions, according to embodiments described herein. For the various modules and functions described herein, one or more computing devices 100 or components of computing device 100 may be used. Devices that include components similar or different to those included in computing device 100 may be used and may be connected to a network and used as a system. One or more processor(s) 105 including cores in processor(s) 105 may be configured to carry out embodiments of the present invention by for example executing software or code.

Storage 130 may be or may include, for example, a hard disk drive, a floppy disk drive, a Compact Disk (CD) drive, a universal serial bus (USB) device or other suitable storage. Data such as instructions, code, NN model data, parameters, etc. may be stored in a storage 130 and may be loaded from storage 130 into a memory 120 where it may be processed by controller 105. In some cases such data may be loaded from a lower level cache to a higher level cache. Some of the components shown in FIG. 4 may be omitted.

Input devices 135 may be or may include for example a mouse, a keyboard, a touch screen etc. Output devices 140 may include displays, speakers and/or any other suitable output devices. Any suitable number of output devices may be operatively connected to computing device 100 as shown by block 140. Any applicable input/output (I/O) devices may be connected to computing device 100.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, cause or configure the processor to carry out methods disclosed herein.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer or other electronic computing device, that manipulates and/or transforms data represented as physical (e.g., electronic) quantities within the computer's registers or memories into other data similarly represented as physical quantities within the computer's registers and/or memories or other non-transitory storage medium that may store instructions to perform operations and/or processes.

The term set when used herein may include zero or more items. Unless explicitly stated, the method embodiments described herein are not constrained to a particular order or sequence. Some of the described method embodiments or elements thereof can occur or be performed simultaneously, at the same point in time, or concurrently.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method of executing a neural network (NN), the method comprising, using a computer processor:
for a matrix A, for each row in A, for each unique value z appearing in one or more locations in the row in A;
summing the set of rows in a matrix B where the set of rows in matrix B correspond to the indices of z in the row in A, the summing producing a vector;
multiplying the vector by the unique value z to produce a product vector; and
adding the product vector to a row in an output matrix C which corresponds to the row in A.

2. The method of claim 1, wherein each value in A is quantized such that each value in A is represented by three or fewer bits; and wherein each value in B is not quantized, such that each value in B is represented by eight or more bits.

3. The method of claim 1, comprising performing inference on the NN by accepting an input to the NN and producing an output from the NN.

4. The method of claim 1, wherein the summing uses add CPU instructions and the multiplication uses multiply CPU instructions.

5. The method of claim 1, wherein the summing uses vector add instructions and the multiplication uses vector multiply instructions.

6. The method of claim 1, comprising producing code for the summing and multiplying based on an input of the matrix A.

7. The method of claim 1, wherein matrix A stores weights or a kernel.

8. The method of claim 1, wherein summing the set of rows in the matrix B comprises partitioning each of the set of rows in the matrix B such that the summing occurs for each partition.

9. A system for executing a neural network (NN), the system comprising:
a memory;
a computer processor to:
for a matrix A, for each row in A, for each unique value z appearing in one or more locations in the row in A;
sum the set of rows in a matrix B where the set of rows in matrix B correspond to the indices of z in the row in A, the summing producing a vector;
multiply the vector by the unique value z to produce a product vector; and
add the product vector to a row in an output matrix C which corresponds to the row in A.

10. The system of claim 9, wherein each value in A is quantized such that each value in A is represented by three or fewer bits; and wherein each value in B is not quantized, such that each value in B is represented by eight or more bits.

11. The system of claim 9, wherein the computer processor is to perform inference on the NN by accepting an input to the NN and producing an output from the NN.

12. The system of claim 9, wherein the summing uses add CPU instructions and the multiplication uses multiply CPU instructions.

13. The system of claim 9, wherein the summing uses vector add instructions and the multiplication uses vector multiply instructions.

14. The system of claim 9, wherein the computer processor is to produce code for the summing and multiplying based on an input of the matrix A.

15. The system of claim 9, wherein matrix A stores weights or a kernel.

16. The system of claim 9, wherein summing the set of rows in the matrix B comprises partitioning each of the set of rows in the matrix B such that the summing occurs for each partition.

17. A method of executing a neural network (NN), the method comprising:
summing activation values in an activation tensor which correspond to one unique value in a weight tensor; and
multiplying the resulting sum by the unique value.

18. The method of claim 17, wherein the summing uses vector add instructions and the multiplying uses vector multiply instructions.

19. The method of claim 17, comprising performing inference on the NN by accepting an input to the NN and producing an output from the NN.

20. The method of claim 17, wherein the summing uses add CPU instructions and the multiply uses multiply CPU instructions.
